(19) United States
(12) Patent Application Publication
(10) Pub. No.: US 2023/0316680 A1
(43) Pub. Date: Oct. 5, 2023

(54) Discovery of Services

(71) Applicant: Apple Inc., Cupertino, CA (US)

(72) Inventors: Jeremy S. Jones, Santa Clara, CA (US); Bruno M. Sommer, Sunnyvale, CA (US); Leanid Vouk, San Carlos, CA (US); Luis R. Deliz Centeno, Oakland, CA (US); Peter F. Handel, San Jose, CA (US); Timofey Grechkin, Sunnyvale, CA (US)

(21) Appl. No.: 18/189,429

(22) Filed: Mar. 24, 2023

Related U.S. Application Data
(63) Continuation of application No. PCT/US2021/051057, filed on Sep. 20, 2021.
(60) Provisional application No. 63/083,314, filed on Sep. 25, 2020.

(51) Int. Cl. G06T 19/00; G06V 20/20; G06F 3/01

(52) U.S. Cl. CPC G06T 19/006; G06V 20/20; G06F 3/017

(57) ABSTRACT

The disclosure pertains to techniques for collaborating in a multi-user communications environment. One such technique includes receiving, at a first communication device, data associated with a multi-user communication session between a first user of the first communication device and a second user of a second communication device, presenting, at the first communication device, a non-extended reality graphical user interface (GUI), the non-extended reality GUI including a non-extended reality representation of a virtual object included in the multi-user communication session and a representation of the second user based on the data associated with the multi-user communication session, and updating, at the first communication device, the non-extended reality GUI to illustrate an interaction between the representation of the second user and the virtual object in response to the data indicating the interaction.

### BACKGROUND

This disclosure relates generally to multi-user environments. More particularly, but not by way of limitation, this disclosure relates to techniques and systems for discovering extended reality (XR) services.

Some devices are capable of generating and presenting XR environments (XRE). An XRE may include a wholly or partially simulated environment that people sense and/or interact with via an electronic system. In an XRE, a subset of a person's physical motions, or representations thereof, are tracked, and, in response, one or more characteristics of one or more virtual elements simulated in the XRE are adjusted in a manner that comports with at least one law of physics. Some XREs allow multiple users to interact with each other within the XRE. However, what is needed is an improved technique to discover XR services and users.

### BRIEF DESCRIPTION OF THE DRAWINGS

FIG. 1 shows, in block diagram form, a simplified system diagram according to one or more embodiments.

FIG. 2 shows a diagram of example operating environments, according to one or more embodiments.

FIGS. 3-5 are block diagrams illustrating example communication environments, in accordance with aspects of the present disclosure.

FIG. 6 is a block diagram illustrating an example communications environment using gestures, in accordance with aspects of the present disclosure.

FIG. 7 is a block diagram illustrating an example communications environment using device sounds, in accordance with aspects of the present disclosure.

FIG. 8 is a block diagram illustrating an example communications environment using user sounds, in accordance with aspects of the present disclosure.

FIG. 9 illustrates a technique for identifying XR services, in accordance with aspects of the present disclosure.

FIGS. 10A and 10B show exemplary systems for use in various XR technologies in accordance with one or more embodiments.

### DETAILED DESCRIPTION

This disclosure pertains to techniques for users seeking to collaborate in a multi-user communication session such as an XR communications session (XRC). The XRC session may be advertised as available to join by other devices local to a first user and these other devices may either be known or unknown to the first user. Additionally, multiple advertised XRC sessions may be available locally to join. To help facilitate joining an intended XRC session, a technique to identify available XRC sessions may be desired. Accordingly, techniques described herein provide a technique for identifying available XRC sessions to join.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an XR environment (XRE) that is wholly or partially simulated. The XRE can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XRE can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XRE (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XRE. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

For purposes of this disclosure, an XR communication (XRC) session refers to an XR environment (XRE) in which two or more devices are participating.

For purposes of this disclosure, a local XRC device refers to a current device being described, or being controlled by a user being described, in an XRC session.

For purposes of this disclosure, colocated XRC devices refer to two or more devices that share a physical environment and an XRC session, such that the uses of the colocated devices may experience the same physical objects and XR objects.

For purposes of this disclosure, a remote XRC device refers to a secondary device that is located in a separate physical environment from a current, local XRC device. In one or more embodiments, the remote XRC device may be a participant in the XRC session.

For purposes of this disclosure, shared virtual elements refer to XR objects that are visible or otherwise able to be experienced in an XRE by participants in an XRC session.

For purposes of this disclosure, an XRC environment (XRCE) refers to a computing environment or container of an XRC session capable of hosting applications. The XRCE enables applications to run within an XRC session. In certain cases, the XRCE may enable users of the XRC session to interaction with hosted applications within the XRC session.

For the purposes of this disclosure, an XRCE instance refers to an XRCE of a current device being described or being controlled by a user being described. The XRCE instance can allow the user to participate in an XRC session and run an application in the XRC session.

For the purposes of this disclosure, a second XRCE instance refers to an XRCE of a secondary device, or being controlled by a second user, in the XRC session, other than the local XRCE instance. The second XRCE instance may be remote or colocated.

For the purposes of this disclosure, an XRCE application refers to an application which is capable of executing within the context of an XRCE.

For the purposes of this disclosure, a second XRCE application refers to an XRCE application of a secondary device, or being controlled by the second user, in the XRC session, other than the local XRCE application. The second XRCE application may be remote or colocated.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

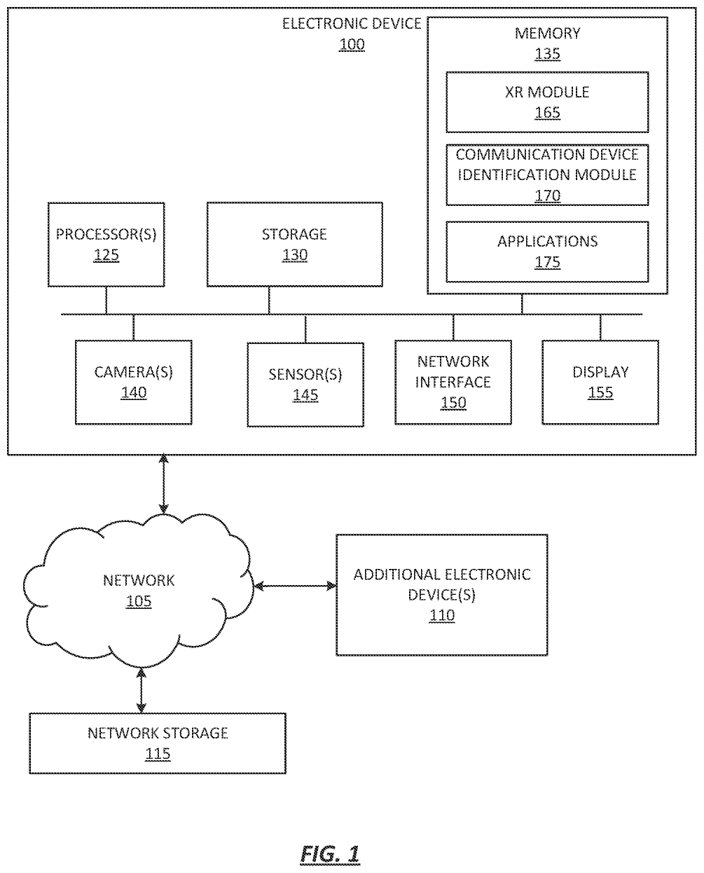

Referring to FIG. 1, a simplified block diagram of an XR electronic device 100 is depicted, communicably connected to additional XR electronic devices 110 and a network storage 115 over a network 105, in accordance with one or more embodiments of the disclosure. The XR electronic device differs from other electronic devices by displaying an XRE in such a way as to allow a user of the XR electronic device to perceive the XRE as a three-dimensional (3D), interactive experience. In contrast other electronic devices may be capable of displaying a two dimensional “window” which may display a 3D perspective projection into the XRE. The XR electronic device 100 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. The XR electronic device 100, additional XR electronic device 110, and/or network storage 115 may additionally, or alternatively, include one or more additional devices within which the various functionality may be contained, or across which the various functionality may be distributed, such as server devices, base stations, accessory devices, and the like. Illustrative networks, such as network 105 include, but are not limited to, a local network such as a universal serial bus (USB) network, an organization's local area network, and a wide area network such as the Internet. According to one or more embodiments, XR electronic device 100 is utilized to participate in an XR XRC session. It should be understood that the various components and functionality within XR electronic device 100, additional XR electronic device 110 and network storage 115 may be differently distributed across the devices or may be distributed across additional devices. The XR electronic device 100 may include a network interface 150, which interfaces with networking components, such as radio, infrared, and/or visible light transceivers for communicating with other devices. The network interface 150 may interface with either wired or wireless networking components, or both.

The XR electronic device 100 may include one or more processors 125, such as a central processing unit (CPU). Processor(s) 125 may include a system-on-chip such as those found in mobile devices and include one or more dedicated graphics processing units (GPUs).

Further, processor(s) 125 may include multiple processors of the same or different type. The XR electronic device 100 may also include a memory 135. Memory 135 may include one or more different types of memory, which may be used for performing device functions in conjunction with processor(s) 125. For example, memory 135 may include cache, ROM, RAM, or any kind of transitory or non-transitory computer readable storage medium capable of storing computer readable code. Memory 135 may store various programming modules for execution by processor(s) 125, including XR module 165, a communication device identification module 170, and other various applications 175. The XR electronic device 100 may also include storage 130. Storage 130 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Storage 130 may be configured to store content items 160, according to one or more embodiments.

The XR electronic device 100 may also include one or more cameras 140 or other sensors 145, such as depth sensor, from which depth of a scene may be determined. In one or more embodiments, each of the one or more cameras 140 may be a traditional RGB camera, or a depth camera. Further, cameras 140 may include a stereo- or other multi-camera system, a time-of-flight camera system, or the like. Information generated by the sensors 145, one or more cameras 140 may be utilized by the communication device identification module 170 to detect and/or connect with other colocated XR devices. The communication device identification module 170 may access the network interface 150 and/or certain types of sensors 145 to obtain information for, or to transmit information to facilitate connecting with other colocated XR devices.

The XR electronic device 100 may also include a display 155. The display device 155 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment for example. as a hologram or on a physical surface.

According to one or more embodiments, memory 135 may include one or more modules that comprise computer readable code executable by the processor(s) 125 to perform functions. The memory may include, for example an XR module 165 which may be used to provide an XRE for a local XRC device in an XRC session. The XRC session may be a computing environment which supports a shared experience by XR electronic device 100 as well as additional XR electronic devices 110.

The memory 135 may also include an OS module 180, for supporting basic functionality and managing hardware of the XR electronic device 100. The OS module 180 provides an environment in which applications 175 may execute within. Applications 175 may include, for example, computer applications that may be experienced in an XRC session by multiple devices, such as XR electronic device 100 and additional XR electronic devices 110.

Although XR electronic device 100 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined.

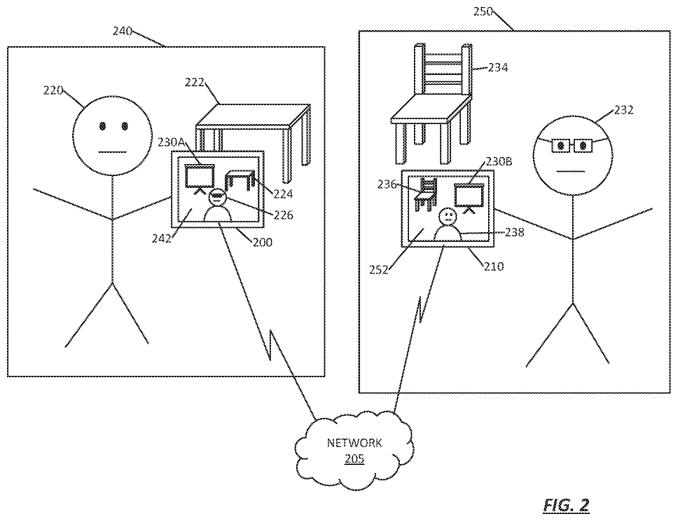

FIG. 2 shows a diagram of example operating environments, according to one or more embodiments. While pertinent features are shown, those of ordinary skill in the art will appreciate from the present disclosure that various other features have not been illustrated for the sake of brevity and so as not to obscure more pertinent aspects of the example among implementations disclosed herein. To that end, as a nonlimiting example, the first operating environment 240 includes a first physical environment, whereas second operating environment 250 includes a second physical environment.

As shown in FIG. 2, the first operating environment 240 includes a first user 220 that is utilizing a first electronic device 200, and the second operating environment 250 includes a second user 232 that is utilizing a second electronic device 210. In one or more embodiments, the first electronic device 200 and the second electronic device 210 include mobile devices, such as handheld devices, wearable devices, and the like.

In one or more embodiments the first electronic device 200 and the second electronic device 210 communicate with each other via a network 205. Examples of network 205 may include, for example, the Internet, a wide area network (WAN), a local area network (LAN), etc. In one or more embodiments, the first electronic device 200 and the second electronic device 210 may be participating in an XRC session.

Although electronic device 200 and second electronic device 210 may be participating in the common XRC session, the virtual environment may be rendered differently on each device. As shown, the electronic device 200 may depict physical objects of the first operating environment 240. As shown, physical table 222 may be depicted on the display 242 as a virtual table 224. In one or more embodiments, the display 242 may be a pass-through display, and virtual table 224 may simply be a view of physical table 222 through display 242.

Display 242 of electronic device 200 may also include an avatar 226 corresponding to user 232 in the second operating environment 250. For purposes of this disclosure, and avatar may include a virtual representation of a user. The avatar may depict real-time actions of the corresponding user 232, including movement, updated location, and/or interactions with various physical components and/or virtual components within the XRC session.

According to one or more embodiments, an XRCE may be an XRE that supports one or more XRCE applications or other modules which provide depictions of XR objects across all participating devices, such as electronic device 200 and second electronic device 210. As shown in display 242, presentation panel 230A is an example of a virtual object which may be visible to all participating devices.

As an example, returning to environment 250, second electronic device 210 includes a display 252, on which the presentation panel virtual object 230B is depicted. It should be understood that in one or more embodiments, although the same virtual object may be visible across all participating devices, the virtual object may be rendered differently according to the location of the electronic device, the orientation of the electronic device, or other physical or virtual characteristics associated with electronic devices 200 and 210 and/or the XRCE depicted within displays 242 and 252.

Returning to environment 250, another characteristic of an XRC session is that while virtual objects may be shared across participating devices, physical worlds may appear different. As such, physical chair 234 is depicted as virtual chair 236. As described above, and one or more embodiments, display 252 may be a pass-through display, and virtual chair 236 may be a view of physical chair 234 through the pass-through display 252. In addition, second electronic device 210 depicts an avatar 238 corresponding to user 220 within physical environment 240.

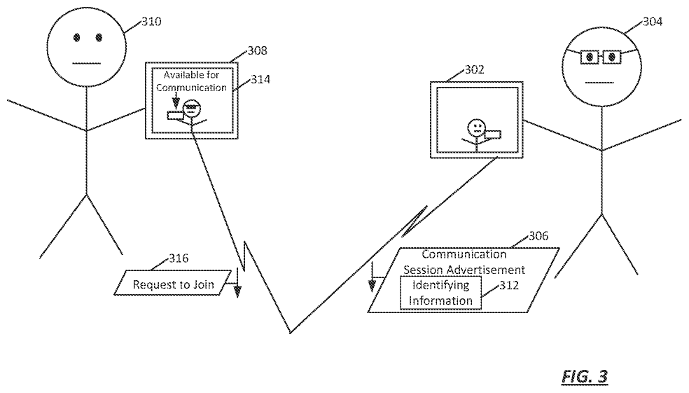

Generally, communication devices may either be colocated or remote. Where two XRC devices share a physical environment, the XRC devices may be colocated. Otherwise, the XRC devices are remote. There may be a desire to establish an XRC session as between colocated XRC devices. In certain cases, a user may want to announce or create an XRC session for other colocated users to join with other XRC devices. For example, a user at a conference may want to utilize an XRC session for demonstration purposes with colocated conference attendees. The user may want to announce the availability of an XRC session to XRC devices of colocated conference attendees. FIG. 3 shows a diagram of XRC session discovery 300, in accordance with aspects of the present disclosure. In this example, a second XRC device 302 associated with a second user 304 may be configured to transmit an XRC session advertisement 306. The XRC session advertisement 306 may be transmitted using a relatively short-range signal. In certain cases, the short-range signal may be a relatively low power signal which generally does not penetrate solid surfaces, such as walls. For example, the XRC session advertisement 306 may be transmitted as a Quick Response (QR) code displayed on a screen. In certain cases, it may be desirable to transmit the XRC session advertisement 306 in a non-visual manner. As an example, the XRC session advertisement 306 may be encoded and broadcast via an infrared (IR) signal, such as via an IR light emitting diode (LED) or IR laser, such as one in an IR dot projector or a time-of-flight camera. In other cases, the XRC session may be advertised using conventional low-power protocol, such as Bluetooth® Low Energy (BLE) (Bluetooth is a registered trademark owned by Bluetooth SIG, Inc.), or using radio frequencies, such as millimeter wave frequencies, which are easily absorbed by objects in their propagating path.

The transmitted XRC session advertisement 306 may be received by a first XRC device 308 associated with a first user 310. For example, the first XRC device 308 may receive the XRC session advertisement 306 via a camera, IR receiver, or appropriate radio frequency receiver. After the XRC session advertisement 306 is received, the first XRC device 308 may display an indication that an XRC session is available. In certain cases, this indication may include identifying information 312 related to the first user. In certain cases, the first XRC device 308 may display an image of a scene, including the second XRC device 302 and/or the second user 304. For example, the first user 310 may point a camera of the first XRC device 308 towards the second XRC device 302 and/or the second user 304, and the first XRC device 308 may display an image of the corresponding scene. Based on the identifying information 312, the first XRC device 308 may determine that the second XRC device 302 is a candidate communication device for establishing an XRC session with and update a graphical user interface of the first XRC device 308 to indicate that the candidate communication device is available to establish an XRC session with. For example, the displayed scene 314 on the first XRC device 308 may be updated to point out the second XRC device 302 in the displayed scene 314 and indicate that an XRC session may be established with the second XRC device 302. The first XRC device 308 may then send a request to join the XRC session to the second XRC device 302. For example, the first user 310 of the first XRC device 302 may be presented with a user interface element allowing them to establish an XRC session with the second XRC device 302 based on the XRC session advertisement 306. Based on an indication received, for example, via this user interface element, the first XRC device 302 may transmit a request to join the XRC session to the second XRC device 302.

As indicated above, the XRC session advertisement 306 may also include identifying information 312. In certain cases, the identifying information 312 may include information identifying the second user 304. For example, the identifying information 312 may include a hash based on a user identity of the second user 304. Transmitting a user hash helps allow a level of privacy for the user, while still allowing other devices to determine whether the user is a known user. In certain cases, the first XRC device 308 may receive the user identity hash of the second user 304 and compare the user identity hash to contact hashes of known users. For example, a contact hash may be generated and stored for each contact of a user. Received user identity hashes may be compared against these stored contact hashes to determine if the second user 304 is known by the first user 310. If the second user 304 is known by the first user 310, then an indication of the second user 304 may be displayed along with an indication that the second user 304 is attempting to establish an XRC session. If an indication to join the XRC session is received by the first XRC device 308 from the first user 310, the request to join 316 the XRC session is sent by the first XRC device 308 to establish the XRC session between the first XRC device 308 and second XRC device 302.

In certain cases, XRC session advertisements may be received from unknown users. How the first XRC device 308 responds to XRC session advertisements 306 from unknown users may be configurable. For example, the first XRC device 308 may be configured to ignore all XRC session advertisements. In such cases, the first XRC device 308 may discard the received XRC session advertisement 306, or the first XRC device may disable receiving XRC session advertisements entirely. As another example, the first XRC device 308 may be configured to disallow XRC session advertisements from unknown users. In such cases, the first XRC device 308 may receive the user identity hash of the second user 304 and determine that the second user 304 is unknown to the first XRC device 308. The first XRC device 308 may then discard the received XRC session advertisement 306. In other cases, the first XRC device 308 may be configured to allow XRC session advertisements from unknown users. In such cases, the first XRC device 308 may display an indication to the first user 310 about the received XRC session advertisement 306. If another indication is received from the first user 310 to accept join the XRC session, then the first XRC device 308 transmits the request to join 316 to the second XRC device 302 to establish the XRC session.

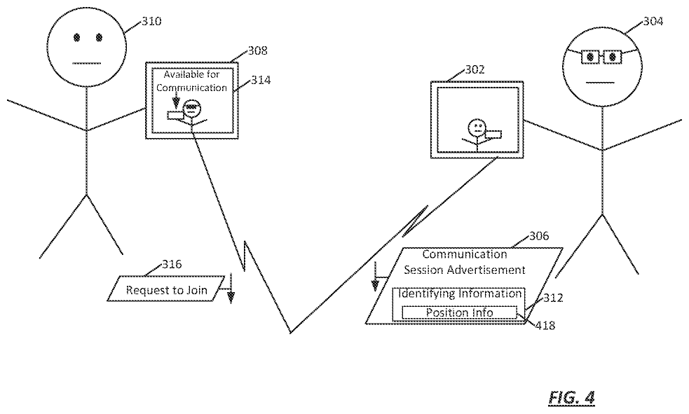

FIG. 4 is a block diagram illustrating an example communications environment 400, in accordance with aspects of the present disclosure. In accordance with aspects of the present disclosure, instead of or in addition to the user identity hash, the identifying information 312 transmitted by the second XRC device 302 in the XRC session advertisement 306 may include positional information 418. This advertised positional information 418 may be information related to a position of the second XRC device 302 in a reference coordinate system. For example, the second XRC device 302 may include one or more position sensors, such as a global positioning system (GPS) sensor, compass, etc., which may be used to provide positional information 418 in a reference coordinate system, such as GPS coordinates and a directional coordinate. In certain cases, the positional information 418 may be based on information determined from sensors or components not specifically intended to provide position information. For example, the positional information 418 may be generated based on cellular signal triangulation, nearby Wi-Fi networks, beacons, such as Bluetooth® beacons, signal strength of an access point, relative locations of other radio frequency sources nearby, a comparison of images captured by a camera against known locations, computer vision based localization techniques (e.g., simultaneous localization and mapping (SLAM), visual inertial odometry (VIO), or the like), etc. As a more specific example, relative positional information based on recognized shapes and/or planes. Image data, such as point cloud or traditional visible light digital images, may be processed to determine a ground plane, ground plane dimensional information, and/or shape information to describe objects in the image data via shape information. In certain cases, objects may be recognized and assigned a corresponding shape. In other cases, objects may be described using one or more shapes, such as by one or more shapes that most closely resemble a respective object. The relative positional information may then be based on how the shapes of the set of shapes and/or ground plane/ground plane dimensional information are oriented relative to each other.

In other cases, positional information 418 may be extracted based on characteristics of the XRC session advertisement 306. For example, the first XRC device 308 may determine a distance to the second XRC device 302 based on a signal strength of the XRC session advertisement 306. This signal strength may be compared against a predetermined signal strength or against a transmission signal strength included in the XRC session advertisement 306. As other examples, the first XRC device 308 may measure a doppler effect, directionality, signal strength across multiple antennas, or other characteristic of the received XRC session advertisement 306 to determine location information about the second XRC device 302. In certain cases, certain techniques for determining positional information may be preferred and falling back to other techniques when the preferred techniques are not available. For example, GPS coordinates may be preferred, but when GPS signals are unavailable, nearby Wi-Fi networks may be used to determine positional information. If nearby Wi-Fi networks are unavailable (e.g., not recognized, Wi-Fi disabled, etc.), then shape recognition may be used.

This position information 418 may be used to help indicate that an XRC session may be established with the second XRC device 302. For example, there may be multiple XRC devices advertising XRC sessions in an area and users may want to be sure that they are trying to connect to the intended XRC session. The positional information 418 may be used to determine which of the multiple XRC devices a particular XRC session announcement is associated with. In certain cases, the first XRC device 308 may determine a relative location of the second XRC device 302 based on the received positional information 418 along with a position of the first XRC device 308. When displaying an image of the scene, the first XRC device 308 may attempt to identify the candidate communication device in the image of the scene based on the positional information 418. For example, the first XRC device 308 may use object recognition techniques to identify XRC devices and/or users within the image of the scene. The first XRC device 308 may also determine a relative location of the recognized XRC devices and/or users using, for example, depth information, the position of the first XRC device 308, and an indication of a direction the first XRC device 308 is facing. Depth information may be provided, for example, by a depth sensor, time-of-flight sensor, or depth sensing based on multiple images. The position of the first XRC device 308, along with directional indication may be obtained, for example, using techniques similar to those useable for determining the positional information 418. The relative locations of the recognized XRC devices and/or users may then be compared to the determined relative location of the second XRC device 302 to identify the candidate communication device and update the displayed scene 314 to point out the second XRC device 302 in the displayed scene 314.

In certain cases, the first XRC device 308 may be configured to ignore received XRC session advertisements greater than a threshold distance away from the first XRC device 308. In such cases, the first XRC device 308 may compare the advertised positional information 418 against a location of the first XRC device 308 to determine a distance of the second XRC device 302. If the determined distance is greater than the threshold distance, the received XRC session advertisement 306 may be discarded.

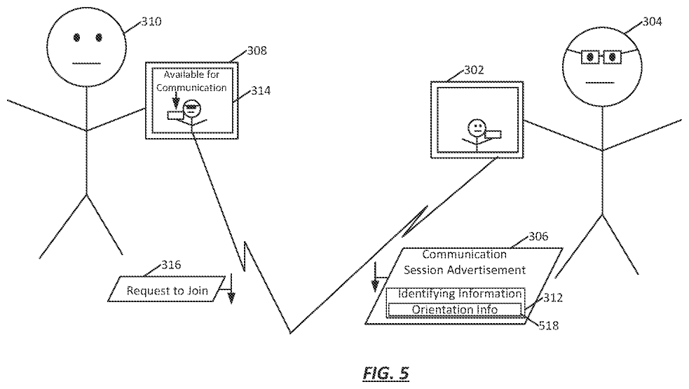

In certain cases, positioning information 418 may be insufficiently precise to be used to determine which XRC device the XRC session advertisement is associated with. For example, GPS accuracy may be degraded in conditions where there is a limited or no view of the sky. As shown in FIG. 5, the identifying information 312 transmitted by the second XRC device 302 may include orientation information 518. The orientation information 518 may be included with or instead of any other information, such as positional information 418. The orientation information 518 may describe an orientation of a user and/or an XRC device associated with the user. For example, the second XRC device 302 may include one or more sensors which may be used to provide orientation information describing how the second XRC device 302 is oriented. For example, gyroscope, gravity, and/or altimeter sensors may be used to provide tilt, angle, and height information. In certain cases, other sensors may be used, such as optical cameras (e.g., using computer vision based techniques, such as SLAM, VIO, or the like), depth sensors, tilt sensors, etc. to determine the orientation of the XRC device in space. In another example, the orientation information may describe an orientation of the user, for example, the second XRC device 302 may be associated with one or more body position sensors and/or imaging devices which may provide orientation information describing how the user is oriented in space and/or how the user is oriented with respect to the second XRC device 302. For example, the orientation information may indicate that the second user is facing a particular direction, how portions of their body are positioned with respect to gravity and/or how the user is oriented relative to other persons or objects around them. This orientation information 518 may be encoded and included with the identifying information 312 and transmitted in the XRC session advertisement 306.

This orientation information may also be used to help indicate that an XRC session may be established with the second XRC device 302. In certain cases, the orientation information 518 may be used to determine which of the multiple XRC devices a particular XRC session announcement is associated with. For example, the orientation information 518 may indicate that the second XRC device 302 is facing a particular direction and is tilted upwards by a first number of degrees and to the left a second number of degrees, and/or is a third number of inches above the ground. In certain cases, the first XRC device 308 may use object recognition techniques to identify XRC devices and/or users within the image of the scene.

The first XRC device 308 may also determine orientation information for the recognized XRC devices and/or users, for example, using object recognition techniques to scale and/or rotate recognized XRC devices and human pose estimation to determine orientation information for users. The first XRC device 308 may, for example, determine rotation information for recognized XRC devices as a part of object recognition process. Based on this rotation information and an orientation of the first XRC device 308, an orientation for the recognized XRC devices may be determined. In certain cases, height information may be determined based on, for example, height and tilt information for the second XRC device 308, relative to recognized XRC devices in the image of the scene. This determined orientation information may then be compared to the received orientation information 518 to identify the candidate communication device. The first XRC devices 308 may then compare the determined orientation information for the recognized XRC devices for a similarly oriented XRC device to identify the candidate communication device. The displayed scene 314 may then be updated to point out the second XRC device 302 and/or second user 304 in the displayed scene 314 as the candidate device.

In certain cases, orientation information 518 from multiple XRC session advertisements 306 may be matched over time, for example, to increase a confidence that the candidate communication device is correctly identified. For example, if multiple recognized XRC devices have an orientation within a threshold distance from the determined orientation, orientation information 518 from multiple XRC session advertisement 306 over a time period may be sampled and compared to multiple determined orientations over the same time period. Obtaining orientation information 518 from multiple XRC session advertisements 306 over time may be helpful as it is unlikely that multiple users associated with XRC devices will orient their respective devices similarly over time.

Orientation information 518 may also be used in conjunction with other information that may be included in the identifying information to identify candidate communication devices. For example, positioning information may be used to narrow down a set of XRC devices and then orientations of the XRC devices in the set of XRC devices may be determined and matched against the received orientation information 518.

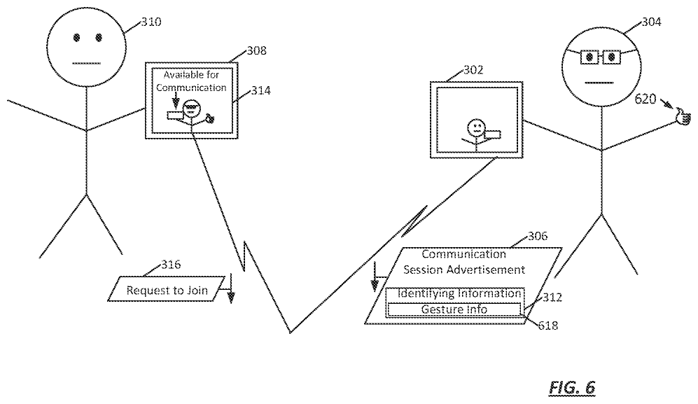

FIG. 6 is a block diagram illustrating an example communications environment using gestures 600, in accordance with aspects of the present disclosure. In certain cases, the XRC devices may request one or more users make one or more gestures. These gestures may be used to help indicate which device and/or user an XRC session may be established with. In this example, the second XRC device 302 may indicate to the second user 304 to make a particular gesture, such as a thumbs up gesture 620 or other gesture, such as raising a particular arm, pointing, nodding, etc. In certain cases, the second user 304 may select a particular gesture to make, for example, from a user interface, such as a menu of potential gestures, displayed by the second XRC device 302. The second XRC device 302 may include gesture information 618 as a part of the identifying information 312 in the XRC session advertisement 306. The gesture information 618 may be included instead of or in addition to the user identity hash, orientation information, position information, etc. The gestures information 618 may describe the gesture requested of, or by, the second user 304. For example, the gesture information 618 may be based on a feature or gesture vector or descriptor describing the expected gesture in a directionally invariant manner.

After receiving the XRC session advertisement 306 and gesture information 618, the first XRC device 308 may use object recognition techniques to identify users making the gesture described by the gesture information 618 within the image of the scene. For example, the first XRC device 308 may apply feature or gesture recognition techniques to search for the gesture described by the gesture information. If a matching gesture is found in the image of the scene, the displayed scene 314 may then be updated to point out the second XRC device 302 and/or second user 304 in the displayed scene 314 as the candidate device.

In certain cases, multiple gestures may be used, for example, to increase a confidence that the candidate communication device is correctly identified. For example, multiple people may raise their hands at once. Matching over multiple gestures reduces a likelihood that multiple people will make the same gestures.

In certain cases, the gesture information 618 may also be used in conjunction with other information that may be included in the identifying information to identify candidate communication devices. For example, positioning or orientation information may be used to narrow down a set of XRC devices and/or associated users and then gestures of associated users may be matched as against the received gesture information 618.

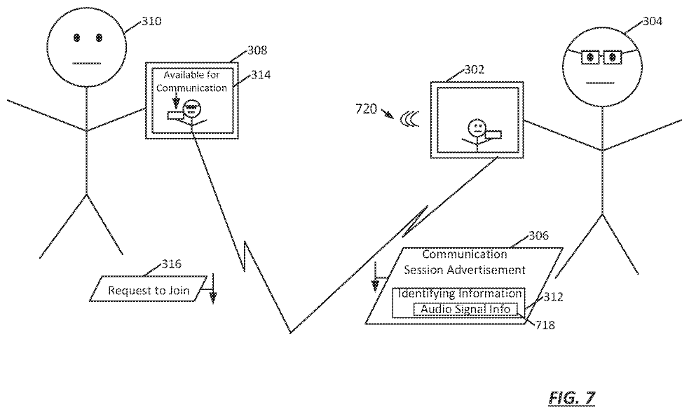

FIG. 7 is a block diagram illustrating an example communications environment using device sounds 700, in accordance with aspects of the present disclosure. In certain cases, the XRC devices may make one or more sounds to help indicate which device an XRC session may be established with. In this example, the second XRC device 302 may include an audio signal information 718 as a part of the identifying information 312 in the XRC session advertisement 306. The audio signal information 718 may be included instead of or in addition to the user identity hash, orientation information, position information, etc. The audio signal information 718 may describe an audio signal 720 that may be sent by the second XRC device 302. After or while the XRC session advertisement 306 is transmitted, the second XRC device 302 may emit the audio signal 720 as described by the audio signal information 718. For example, the audio signal information 718 may describe a number of beeps at a certain frequency followed by a pause of a certain amount of time, followed by a longer beep, etc. The second XRC device 302 may emit the audio signal 720 while transmitting the XRC session advertisement 306. In certain cases, the audio signal 720 may be emitted at frequencies inaudible to human ears, such as at ultrasonic frequencies.

After receiving the XRC session advertisement 306 and audio signal information 718, the first XRC device 308 may attempt to detect the emitted audio signal 720. For example, the first XRC device 308 may include one or more microphones capable of receiving audio signals. These audio signals may be analyzed to determine whether a received audio signal corresponds to the audio signal information 718 has been detected. In certain cases, the first XRC device 308 may include multiple microphones and use stereo localization techniques to determine a direction of the received audio signal. In certain cases, the first XRC device 308 may be turned in various directions to help determine the direction of the received audio signal. For example, the first XRC device 308 may request that the first user 310 turn the first XRC device 308 left and right a number of times to help better locate the received audio or provide a broader stereo baseline. The displayed scene 314 may then be updated to point out the second XRC device 302 and/or second user 304 in the displayed scene 314 as the candidate device based on the determined direction of the received audio signal.

In certain cases, the audio signal information 718 may also be used in conjunction with other information that may be included in the identifying information to identify candidate communication devices. For example, positioning or orientation information may be used to narrow down a direction in which to try to detect the audio signal 720. Further, detected gestures performed by other users may increase the confidence that the candidate communication device is correctly identified.

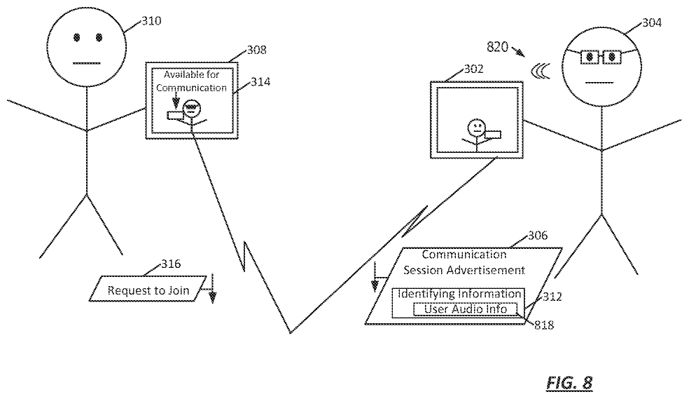

FIG. 8 is a block diagram illustrating an example communications environment using user sounds 800, in accordance with aspects of the present disclosure. In certain cases, the XRC devices may utilize a user produced sound to help indicate which device an XRC session may be established with. In this example, the second XRC device 302 may include user audio information 818 as a part of the identifying information 312 in the XRC session advertisement 306. The user audio information 818 may be included instead of or in addition to the user identity hash, orientation information, position information, etc. The user audio information 818 may describe a user audio 820 emitted by the second user 304. In certain cases, the user audio information 818 may be a voice fingerprint of the second user 304 or encoded speech of the second user 304.

After receiving the XRC session advertisement 306 and user audio information 818, the first XRC device 308 may attempt to detect the user audio 820. For example, the first XRC device 308 may include one or more microphones capable of receiving audio signals. These audio signals may be analyzed to determine whether a received audio signal corresponds with the user audio information 818. For example, the first XRC device 308 may include detect the presence of speech in the received audio signal and compare the detected speech against a voice fingerprint or encoded speech of the second user. In certain cases, the first XRC device 308 may include multiple microphones and use stereo localization techniques to determine a direction of the received audio signal. In certain cases, the first XRC device 308 may be turned in various directions to help determine the direction of the received audio signal. For example, the first XRC device 308 may request that the first user 310 turn the first XRC device 308 left and right a number of times to help better locate the received audio or provide a broader stereo baseline. The displayed scene 314 may then be updated to point out the second XRC device 302 and/or second user 304 in the displayed scene 314 as the candidate device based on the determined direction of the received audio signal.

In certain cases, the user audio information 818 may also be used in conjunction with other information that may be included in the identifying information to identify candidate communication devices. For example, positioning or orientation information may be used to narrow down a direction in which to try to detect the user audio 820. Further, detected gestures performed by other users or audio output by another device may increase the confidence that the candidate communication device is correctly identified.

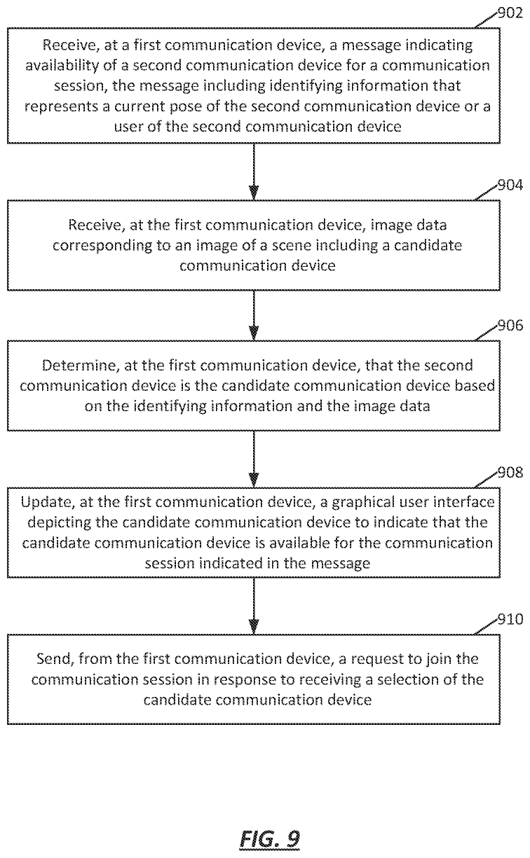

FIG. 9 illustrates a technique 900 for identifying XR services, in accordance with aspects of the present disclosure. At block 902, a first communication device receives a message indicating availability of a second communication device for a communication session, the message including identifying information that represents a current pose of the second communication device or a user of the second communication device. For example, a second communications device may transmit an XRC session advertisement. This XRC session advertisement may include identifying information for the second communications device and/or a second user associated with the second communications device. In certain cases, this identifying information may include position information, orientation information, gesture information, audio signal information, and/or user audio information. The XRC session advertisement may be received by a first communications device. At block 904, the first communication device receives image data corresponding to an image of a scene including a candidate communication device. For example, the first communications device may include a camera that may be pointed towards the second communications device and the first communications device may display a corresponding image on a display of the first communications device. At block 906, the first communications device determines that the second communication device is the candidate communication device based on the identifying information and the image data. In certain cases, the image data may include other image-based input, such as point or dot data (e.g., a point cloud), for example, from an IR dot projector, laser projector, and/or time of flight camera. For example, the first communications device may use the identifying information along with position information, orientation information, gesture information, audio signal information, and/or user audio information, if available, to identify the second communications device in the image. At block 908, the first communications device updates a graphical user interface depicting the candidate communication device to indicate that the candidate communication device is available for the communication session indicated in the message. For example, the first communications device may update the displayed image with an indication that an XRC session may be established with the second communications device. At block 910, the first communications device sends a request to join the communication session in response to receiving a selection of the candidate communication device. For example, the first communication device may send a response to the XRC session advertisement requesting to join or start the XRC session.

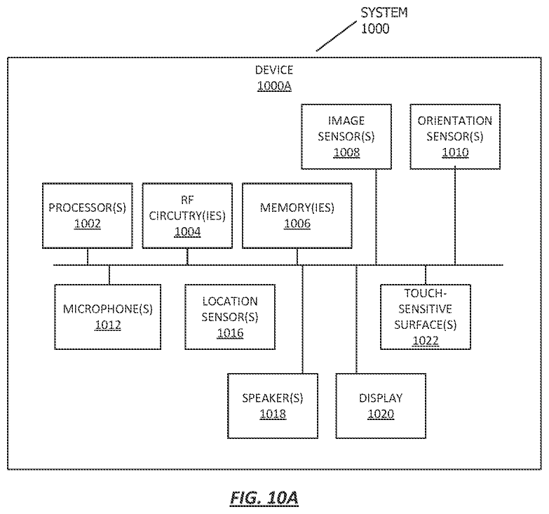

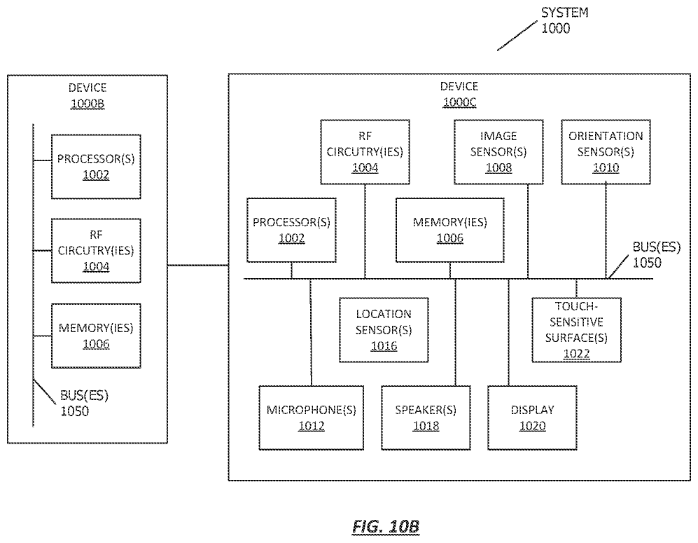

FIG. 10A and FIG. 10B depict exemplary system 1000 for use in various XR technologies.

In some examples, as illustrated in FIG. 10A, system 1000 includes device 1000A. Device 1000A includes various components, such as processor(s) 1002, RF circuitry(ies) 1004, memory(ies) 1006, image sensor(s) 1008, orientation sensor(s) 1010, microphone(s) 1012, location sensor(s) 1016, speaker(s) 1018, display(s) 1020, and touch-sensitive surface(s) 1022. These components optionally communicate over communication bus(es) 1050 of device 1000A.

In some examples, elements of system 1000 are implemented in a base station device (e.g., a computing device, such as a remote server, mobile device, or laptop) and other elements of system 1000 are implemented in a second device (e.g., a head-mounted device). In some examples, device 1000A is implemented in a base station device or a second device.

As illustrated in FIG. 10B, in some examples, system 1000 includes two (or more) devices in communication, such as through a wired connection or a wireless connection. First device 1000B (e.g., a base station device) includes processor(s) 1002, RF circuitry(ies) 1004, and memory(ies) 1006. These components optionally communicate over communication bus(es) 1050 of device 1000B. Second device 1000c (e.g., a head-mounted device) includes various components, such as processor(s) 1002, RF circuitry(ies) 1004, memory(ies) 1006, image sensor(s) 1008, orientation sensor(s) 1010, microphone(s) 1012, location sensor(s) 1016, speaker(s) 1018, display(s) 1020, and touch-sensitive surface(s) 1022. These components optionally communicate over communication bus(es) 1050 of device 1000c.

System 1000 includes processor(s) 1002 and memory(ies) 1006. Processor(s) 1002 include one or more general processors, one or more graphics processors, and/or one or more digital signal processors. In some examples, memory(ies) 1006 are one or more non-transitory computer-readable storage mediums (e.g., flash memory, random access memory) that store computer-readable instructions configured to be executed by processor(s) 1002 to perform the techniques described below.

System 1000 includes RF circuitry(ies) 1004. RF circuitry(ies) 1004 optionally include circuitry for communicating with electronic devices, networks, such as the Internet, intranets, and/or a wireless network, such as cellular networks and wireless local area networks (LANs). RF circuitry(ies) 1004 optionally includes circuitry for communicating using near-field communication and/or short-range communication, such as Bluetooth®.

System 1000 includes display(s) 1020. Display(s) 1020 may have an opaque display. Display(s) 1020 may have a transparent or semi-transparent display that may incorporate a substrate through which light representative of images is directed to an individual's eyes. Display(s) 1020 may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one example, the transparent or semi-transparent display may transition selectively between an opaque state and a transparent or semi-transparent state. Other examples of display(s) 1020 include heads up displays, automotive windshields with the ability to display graphics, windows with the ability to display graphics, lenses with the ability to display graphics, tablets, smartphones, and desktop or laptop computers. Alternatively, system 1000 may be designed to receive an external display (e.g., a smartphone). In some examples, system 1000 is a projection-based system that uses retinal projection to project images onto an individual's retina or projects virtual objects into a physical setting (e.g., onto a physical surface or as a holograph).

In some examples, system 1000 includes touch-sensitive surface(s) 1022 for receiving user inputs, such as tap inputs and swipe inputs. In some examples, display(s) 1020 and touch-sensitive surface(s) 1022 form touch-sensitive display(s).

System 1000 includes image sensor(s) 1008. Image sensors(s) 1008 optionally include one or more visible light image sensor, such as charged coupled device (CCD) sensors, and/or complementary metaloxide—semiconductor (CMOS) sensors operable to obtain images of physical elements from the physical setting. Image sensor(s) also optionally include one or more infrared (IR) sensor(s), such as a passive IR sensor or an active IR sensor, for detecting infrared light from the physical setting. For example, an active IR sensor includes an IR emitter, such as an IR dot emitter, for emitting infrared light into the physical setting. Image sensor(s) 1008 also optionally include one or more event camera(s) configured to capture movement of physical elements in the physical setting. Image sensor(s) 1008 also optionally include one or more depth sensor(s) configured to detect the distance of physical elements from system 1000. In some examples, system 1000 uses CCD sensors, event cameras, and depth sensors in combination to detect the physical setting around system 1000. In some examples, image sensor(s) 1008 include a first image sensor and a second image sensor. The first image sensor and the second image sensor are optionally configured to capture images of physical elements in the physical setting from two distinct perspectives. In some examples, system 1000 uses image sensor(s) 1008 to receive user inputs, such as hand gestures. In some examples, system 1000 uses image sensor(s) 1008 to detect the position and orientation of system 1000 and/or display(s) 1020 in the physical setting. For example, system 1000 uses image sensor(s) 1008 to track the position and orientation of display(s) 1020 relative to one or more fixed elements in the physical setting.

In some examples, system 1000 includes microphones(s) 1012. System 1000 uses microphone(s) 1012 to detect sound from the user and/or the physical setting of the user. In some examples, microphone(s) 1012 includes an array of microphones (including a plurality of microphones) that optionally operate in tandem, such as to identify ambient noise or to locate the source of sound in space of the physical setting.

System 1000 includes orientation sensor(s) 1010 for detecting orientation and/or movement of system 1000 and/or display(s) 1020. For example, system 1000 uses orientation sensor(s) 1010 to track changes in the position and/or orientation of system 1000 and/or display(s) 1020, such as with respect to physical elements in the physical setting. Orientation sensor(s) 1010 optionally include one or more gyroscopes and/or one or more accelerometers.

The techniques defined herein consider the option of obtaining and utilizing a user's personal information. For example, one aspect of the present technology is automatically determining whether a particular device can display an XR view of an XRC session. However, to the extent such personal information is collected, such information should be obtained with the user's informed consent, such that the user has knowledge of and control over the use of their personal information.

Parties having access to personal information will utilize the information only for legitimate and reasonable purposes, and will adhere to privacy policies and practices that are at least in accordance with appropriate laws and regulations. In addition, such policies are to be well-established, user-accessible, and recognized as meeting or exceeding governmental/industry standards. Moreover, the personal information will not be distributed, sold, or otherwise shared outside of any reasonable and legitimate purposes.

Users may, however, limit the degree to which such parties may obtain personal information. The processes and devices described herein may allow settings or other preferences to be altered such that users control access of their personal information. Furthermore, while some features defined herein are described in the context of using personal information, various aspects of these features can be implemented without the need to use such information. As an example, a user's personal information may be obscured or otherwise generalized such that the information does not identify the specific user from which the information was obtained.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIG. 9 or the arrangement of elements shown in FIGS. 1-8 and 10A-10B should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
receiving, at a first communication device, a message indicating availability of a second communication device for a communication session, the message including identifying information that represents a current pose of the second communication device or a user of the second communication device;
receiving, at the first communication device, image data corresponding to an image of a scene including a candidate communication device;
determining, at the first communication device, that the second communication device is the candidate communication device based on the identifying information and the image data;
updating, at the first communication device, a graphical user interface depicting the candidate communication device to indicate that the candidate communication device is available for the communication session indicated in the message; and
sending, from the first communication device, a request to join the communication session in response to receiving a selection of the candidate communication device.

2. The method of claim 1, wherein the communication session corresponds to a shared extended reality experience.

3. The method of claim 1, wherein the current pose includes a position of the second communication device in a reference coordinate system, and wherein determining that the second communication device is the candidate communication device based on the identifying information and the image data includes:
determining a local position of the first communication device in the reference coordinate system;
determining a relative position of the candidate communication device with respect to the first communication device based on the image data;
determining a candidate position of the candidate communication device in the reference coordinate system based on the local position and the relative position; and
matching the candidate position to the advertised position.

4. The method of claim 3, wherein the reference coordinate system corresponds to a global coordinate system, and wherein the local position is determined based on global positioning system device included in the first communication device.

5. The method of claim 1, wherein the current pose includes an orientation of the second communication device in a reference coordinate system, and wherein determining that the second communication device is the candidate communication device based on the identifying information and the image data includes:
determining a local orientation of the first communication device in the reference coordinate system;
determining a relative orientation of the candidate communication device with respect to the first communication device based on the image data;
determining a candidate orientation of the candidate communication device in the reference coordinate system based on the local orientation and the relative orientation; and
matching the candidate orientation to the advertised orientation.

6. The method of claim 1, wherein the current pose includes a gesture of a user of the second communication device, and wherein determining the second communication device is the candidate communication device based on the identifying information and the image data includes:
determining a candidate gesture of a user of the candidate communication device based on the image data; and
matching the candidate gesture to the advertised gesture.

7. The method of claim 1, wherein the current pose includes a height of the user of the second communication device, and wherein determining the second communication device is the candidate communication device based on the identifying information and the image data includes:
determining a local height of a user of the first communication device;
determining a difference in height of the user of the first communication device and a user of the candidate communication device based on the image data;
determining a candidate height of the user of the candidate communication device based on the local height and the difference; and
matching the candidate height to the advertised height.

8. The method of claim 1, wherein the identifying information includes an advertised sound signature, and wherein determining the second communication device is the candidate communication device based on the identifying information and the image data includes:
detecting the advertised sound signature;
determining a source direction of the detected advertised sound signature;
determining a relative location of the candidate communication device to the first communication device based on the image data; and
matching the source direction to the relative location.

9. The method of claim 8, wherein the advertised sound signature corresponds to a vocal fingerprint of a user of the second communication device.

10. A computer readable storage device storing instructions executable by one or more processors to:
receive, at a first communication device, a message indicating availability of a second communication device for a communication session, the message including identifying information that represents a current pose of the second communication device or a user of the second communication device;
receive, at the first communication device, image data corresponding to an image of a scene including a candidate communication device;
determine, at the first communication device, that the second communication device is the candidate communication device based on the identifying information and the image data;
update, at the first communication device, a graphical user interface depicting the candidate communication device to indicate that the candidate communication device is available for the communication session indicated in the message; and
send, from the first communication device, a request to join the communication session in response to receiving a selection of the candidate communication device.

11. The computer readable storage device of claim 10, wherein the communication session corresponds to a shared augmented reality experience.

12. The computer readable storage device of claim 10, wherein the current pose information includes a position of the second communication device in a reference coordinate system, and wherein determining that the second communication device is the candidate communication device based on the identifying information and the image data includes:
determining a local position of the first communication device in the reference coordinate system;
determining a relative position of the candidate communication device with respect to the first communication device based on the image data;
determining a candidate position of the candidate communication device in the reference coordinate system based on the local position and the relative position; and
matching the candidate position to the advertised position.

13. The computer readable storage device of claim 12, wherein the reference coordinate system corresponds to a global coordinate system, and wherein the local position is determined based on global positioning system device included in the first communication device.

14. The computer readable storage device of claim 10, wherein the current pose includes an orientation of the second communication device in a reference coordinate system, and wherein determining that the second communication device is the candidate communication device based on the identifying information and the image data includes:
determining a local orientation of the first communication device in the reference coordinate system;
determining a relative orientation of the candidate communication device with respect to the first communication device based on the image data;
determining a candidate orientation of the candidate communication device in the reference coordinate system based on the local orientation and the relative orientation; and
matching the candidate orientation to the advertised orientation.

15. The computer readable storage device of claim 10, wherein the current pose includes a gesture of a user of the second communication device, and wherein determining the second communication device is the candidate communication device based on the identifying information and the image data includes:
determining a candidate gesture of a user of the candidate communication device based on the image data; and
matching the candidate gesture to the advertised gesture.

16. The computer readable storage device of claim 10, wherein the current pose includes a height of the user of the second communication device, and wherein determining the second communication device is the candidate communication device based on the identifying information and the image data includes:
determining a local height of a user of the first communication device;
determining a difference in height of the user of the first communication device and a user of the candidate communication device based on the image data;
determining a candidate height of the user of the candidate communication device based on the local height and the difference; and
matching the candidate height to the advertised height.

17. The computer readable storage device of claim 10, wherein the identifying information includes an advertised sound signature, and wherein determining the second communication device is the candidate communication device based on the identifying information and the image data includes:
detecting the advertised sound signature;
determining a source direction of the detected advertised sound signature;
determining a relative location of the candidate communication device to the first communication device based on the image data; and
matching the source direction to the relative location.

18. The computer readable storage device of claim 17, wherein the advertised sound signature corresponds to a vocal fingerprint of a user of the second communication device.

19. A device comprising:
one or more processors; and
a memory storing instructions executable by one or more processors to:
receive, at a first communication device, a message indicating availability of a second communication device for a communication session, the message including identifying information that represents a current pose of the second communication device or a user of the second communication device;
receive, at the first communication device, image data corresponding to an image of a scene including a candidate communication device;
determine, at the first communication device, that the second communication device is the candidate communication device based on the identifying information and the image data;
update, at the first communication device, a graphical user interface depicting the candidate communication device to indicate that the candidate communication device is available for the communication session indicated in the message; and
send, from the first communication device, a request to join the communication session in response to receiving a selection of the candidate communication device.

20. The device of claim 19, wherein the current pose information includes a position of the second communication device in a reference coordinate system, and wherein determining that the second communication device is the candidate communication device based on the identifying information and the image data includes:
determining a local position of the first communication device in the reference coordinate system;
determining a relative position of the candidate communication device with respect to the first communication device based on the image data;
determining a candidate position of the candidate communication device in the reference coordinate system based on the local position and the relative position; and
matching the candidate position to the advertised position.
